(19) United States
(12) Patent Application Publication
(10) Pub. No.: US 2026/0127676 A1
(43) Pub. Date: May 7, 2026

(54) AUTOMATED DOCUMENT ANALYSIS AND CERTIFICATE OF INSURANCE GENERATION FROM UNSTRUCTURED INSURANCE COVERAGE DOCUMENTS

(71) Applicant: Aon Risk Services, Inc. of Maryland, Baltimore, MD (US)

(72) Inventors: Sudipto Shankar Dasgupta, Sunnyvale, CA (US); Raju Debroy, Hoffman Estates, IL (US); Abdul Razack, Cupertino, CA (US); Shazia Pappa, Chicago, IL (US); Liam Montgomery, Chicago, IL (US); Erin Alder, Hawthorn Woods, IL (US); Anthony Amaro, Buffalo Grove, IL (US); Amanda Van Heck, Mount Prospect, IL (US); Russell Lee Antrim, Arlington Heights, IL (US)

(73) Assignee: Aon Risk Services, Inc. of Maryland, Baltimore, MD (US)

(21) Appl. No.: 18/934,432

(22) Filed: Nov. 1, 2024

(51) Int. Cl. G06Q 40/08

(52) U.S. Cl. CPC G06Q 40/08

(57) ABSTRACT

In an illustrative embodiment, systems and methods for automatically generating a certificate of insurance (COI) include extracting, from a request document, certificate of insurance parameters detailing a request for COI, extracting, by at least one artificial intelligence classifier from unstructured insurance policy document(s), policy attribute values, converting each policy attribute value to a vector form, applying artificial intelligence to analyzing the vector forms in light of a knowledge ontology to identify a set of COI field values for populating a certificate of insurance template, and populating the certificate of insurance template with the set of COI field values to generate the COI.

### BACKGROUND

A certificate of insurance (COI) serves as proof that a business or individual holds an active insurance policy. A COI is often requested by businesses or individuals before getting into a contract or agreement for any commercial business transactions. It provides key details of the insurance policy (e.g., certificate holder's name, producers, insurance carrier, policy number, effective dates, types of coverage, limits, additional insured, endorsements, etc.). In the commercial insurance business space, it is common practice for entities to share property and casualty insurance coverages for a variety of reasons, including loan closings, building access, and regulatory. Often one or both entities will require very specific details to be displayed on the COI. The COI producers (e.g., brokers) must gather these specific details from a collection of unstructured documents and painstakingly validate the resultant certificate against the policies to ensure the COI is in fact properly representing the coverage.

A COI produced in between renewal periods are referred to as “ad hoc.” Brokers receive hundreds of thousands of requests for ad hoc certificates each year. Ad hoc certificates are often difficult to forecast and needed urgently for a specific business reason, creating friction between the broker, the client, and (where applicable) the client's business partner. Oftentimes, the information necessary to fill in the key details for the ad hoc certification is scattered across various documents retained by various systems. Further, there is limited standardization among the generally manual workflows used across clients and industries for generating ad hoc certificates. Hence, this process is highly manual, time-consuming, and error prone, resulting in a poor client and broker experience. The churn in this process creates material business expenditures for the client and the broker.

The inventors recognized that a highly automated mechanism for generating certificates of insurance, especially ad hoc certifications, would create many benefits, including reducing the time for certificate generation, reducing mistakes within the document typically introduced through human error, and aiding producers in consistently producing a more accurate COI. These benefits would result in both a better end user experience for both clients and brokers, as well as significantly reduced operational expenditure.

### SUMMARY OF ILLUSTRATIVE EMBODIMENTS

In one aspect, the present disclosure relates to automatically extracting detailed information from insurance certificate request documents, comparing the information with existing policy documents, and flagging any deviation within the details of the collective documents. A fine-tuned Large Language Model (LLM)-driven extraction of the detailed information from the policies and contract documents, for example, may be augmented with an insurance-specific ontology to drive processing of the output in a standardized format despite variation in the source document formatting (e.g., due to variations in carrier document templates, variations in terminology applied by the drafters, etc.). Flagged deviation(s), for example, may be presented for end user review and resolution.

In one aspect, the present disclosure relates to methods and systems for automatically generating certificates of insurance documents from policy data extracted from existing policy documents in accordance with policy parameters. The policy parameters may be entered by a requesting user and/or extracted from one or more files related to a certificate of insurance request. The files, in some examples, may include one or more emails, one or more email attachments, one or more electronically submitted files, and/or one or more voicemail recordings.

In one aspect, the present disclosure relates to methods and systems for populating attribute fields of a certificate of insurance template with details extracted from a collection of unstructured documents. The attributes, for example, may be organized in accordance with an insurance servicing knowledge ontology, pairing each data entry field of the certificate of insurance template with one or more corresponding attributes related to a certificate of insurance request or derived from an insurance policy. Business entity attributes, in another example, may be organized in a data store in a manner capturing relationships between entities. The methods and systems, further to the example, may identify entities related to certificate of insurance requests, such as policy holders, COI requesters, and insurance carriers, based in part on the relationship connections between entities within the data store. The data store may be organized, in some examples, as a knowledge ontology or taxonomy.

In one aspect, the present disclosure relates to a system for automating creation of ad hoc certificates of insurance, the system including one or more first non-transitory storage devices configured to store a knowledge ontology including semantically linked relationships between insurance policy attributes and fields within at least one certificate of insurance template. The system may include one or more second non-transitory storage devices configured to store semantically linked high-dimensional vector representations of portions of each insurance policy document of a set of insurance policy documents, where the semantically linked high-dimensional vector representations include insurance policy attribute values corresponding to at least a subset of the insurance policy attributes. The system may include one or more third non-transitory storage devices configured to store at least one large language model (LLM) tuned to assess completeness and accuracy of a subset of insurance policy attribute values to be used for certificate of insurance generation. The system may include processing circuitry configured to identify, within at least one request document, certificate of insurance parameters detailing a request for certificate of insurance, where the certificate of insurance parameters include one or more of a policy number, a policy holder name, a policy holder contact information, or a type of insurance policy. The processing circuitry may be configured to access, from the one or more second non-transitory storage devices, vector representations corresponding to at least one insurance policy document of the set of insurance policy documents, where the at least one insurance policy document is associated with the request for certificate of insurance. The processing circuitry may be configured to analyze, by the at least one LLM, the vector representations to identify a set of insurance policy attribute values relevant to the request for certificate of insurance, where the insurance policy attribute values include one or more values corresponding to one or more of an effective date, an expiration date, a limit, or a deductible. The processing circuitry may be configured to match each data entry field of a number of data entry fields of a certificate of insurance template with a respective one or more insurance policy attribute values of the set of insurance policy attribute values or one or more certificate of insurance parameters of the certificate of insurance parameters, where the matching is performed in accordance with the knowledge ontology. The processing circuitry may be configured to present, on a display of a remote computing device, an interactive graphical user interface for reviewing and revising a digital rendition of a certificate of insurance, the digital rendition of the certificate of insurance including, based on the matching of each data entry field with the respective one or more corresponding values, filled data fields including values of at least a portion of the insurance policy attributes and at least a portion of the certificate of insurance parameters.

In some implementations, the at least one request document includes an email document. Identifying the certificate of insurance parameters may include identifying at least one certificate of insurance parameter from a metadata portion of the email document. Identifying the certificate of insurance parameters may include applying at least one natural language processing technique to extract at least a portion of the certificate of insurance parameters from one or more request documents of the at least one request document.

In some implementations, analyzing the at least one insurance policy document includes classifying each insurance policy attribute value according to a classification schema defined in part by the knowledge ontology. The semantically linked high-dimensional vector representations may be stored within a semantic graph structure. Matching each data entry field of the certificate of insurance template with the respective one or more corresponding values may include enhancing the semantically linked high-dimensional vector representations of each insurance policy attribute value with a tag or link referencing a respective data entry field of the data entry fields of the certificate of insurance template. The at least one LLM may match each data entry field of the certificate of insurance template with the respective one or more corresponding values. In some implementations, the digital rendition of the certificate of insurance includes a thumbnail image of each page of the certificate of insurance.

The processing circuitry may be further configured to, prior to analyzing the vector representations, extracting, from each unstructured insurance policy document of at least one unstructured insurance policy document, a set of insurance policy attribute values corresponding to at least a portion of the insurance policy attributes. The processing circuitry may be further configured to, prior to analyzing the vector representations, converting each respective insurance policy attribute value of the set of insurance policy attribute values to a numeric format arranged in a high-dimensional vector form. The processing circuitry may be further configured to, prior to analyzing the vector representations, storing the high-dimensional vector forms of the set of insurance policy attribute values to the one or more second non-transitory storage devices.

In some implementations, the system further includes one or more fourth non-transitory storage devices configured to store at least one machine learning model configured to recognize the insurance policy attributes within the set of insurance policy documents. The at least one machine learning model may extract the set of insurance policy attributes. Storing the high-dimensional vector forms of the set of insurance policy attribute values may include clustering the high-dimensional vector forms into semantic relationships linked within a knowledge graph. The knowledge graph may be stored to the one or more second non-transitory storage devices.

In some implementations, the system further includes a second knowledge ontology including semantically linked relationships between business entities. The number of business entities may include insurance policy holders. The processing circuitry may be further configured to analyze at least a portion of the certificate of insurance parameters in view of the second knowledge ontology to enhance entity details related to at least one of the policy holder name, the policy holder contact information, a certificate holder, or an insurance carrier.

In some implementations, at least a portion of the processing circuitry includes hardware logic hard-coded or programmed into the portion of the processing circuitry.

In one aspect, the present disclosure relates to a system for automatically generating a certificate of insurance, the system including an insurance-specific ontology stored to one or more first non-transitory computer-readable mediums, the insurance-specific ontology including semantically linked relationships among insurance policy attributes. The system may include a knowledge graph stored to one or more second non-transitory computer-readable mediums, the knowledge graph including semantically linked vector forms of policy attributes derived from unstructured insurance policy documents. The system may include at least one artificial intelligence classifier stored to one or more third non-transitory computer-readable mediums, the at least one artificial intelligence classifier being trained to recognize the insurance policy attributes within the unstructured insurance policy documents. The system may include at least one large language model (LLM) stored to one or more fourth non-transitory computer-readable mediums, the at least one LLM being tuned to assess completeness and accuracy of a subset of insurance policy attribute values to be used for certificate of insurance generation. The system may include one or more processors configured to perform a number of operations. The operations may include extracting, from at least one request document, certificate of insurance parameters detailing a request for certificate of insurance, where certificate of insurance parameters include one or more of a policy number, a policy holder name, a policy holder contact information, or a type of insurance policy. The operations may include extracting, by the at least one artificial intelligence classifier from each unstructured insurance policy document of at least one unstructured insurance policy document, insurance policy attribute values corresponding to a set of insurance policy attributes. The operations may include converting each respective insurance policy attribute value to a numeric format arranged in a high-dimensional vector form. The operations may include storing the high-dimensional vector forms of the insurance policy attribute values to the knowledge graph. The operations may include prompting the at least one LLM to apply a portion of the high-dimensional vector forms and the knowledge graph to collect and provide a set of COI field values. The set of COI field values may include a set of insurance policy attribute values and a portion of the certificate of insurance parameters for generating a certificate of insurance based on a corresponding certificate of insurance template. The operations may include populating the certificate of insurance template with the set of COI field values.

In some implementations, the at least one request document includes an email document. The email document may include, as at least one attachment, one or more unstructured insurance policy documents of the at least one unstructured insurance policy document.

In some implementations, the operations further include tagging the high-dimensional vector forms of the insurance policy attribute values according to the knowledge graph. The operations may further include, prior to prompting the at least one LLM, generating, for review at a remote computing device, an interactive graphical user interface for reviewing and approving the tagging of the high-dimensional vector forms of the n insurance policy attribute values.

In some implementations, the operations further include linking, within the knowledge graph, each high-dimensional vector form of at least a portion of the high-dimensional vector forms to sections of a standardized certificate of insurance template. The operations may further include presenting, on a display of a remote computing device, an interactive graphical user interface for reviewing and revising the populated certificate of insurance template. The at least one LLM may further identify the certificate of insurance template from a number of certificate of insurance templates.

The foregoing general description of the illustrative embodiments and the following detailed description thereof provide mere examples of various aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. In the drawings:

FIG. 1 is a block diagram of an example system for extracting certificate of insurance request parameters obtained from a collection of documents, analyzing policy information to extract contract data related to each certificate of insurance request, and applying the contract data in generating a corresponding certificate of insurance;

FIG. 2 is a flow diagram of an example process for extracting and organizing policy attributes from unstructured and/or semi-structured documents;

FIG. 3 is a flow chart of an example method for analyzing email documents to classify policy-related information and/or certificate of insurance parameters contained therein;

FIG. 4 is a flow chart of an example method for converting policy information culled from document contents into semantically linked relationships;

FIG. 5 is an example graphical user interface for enabling end user confirmation and/or adjustment of semantically linked information;

FIG. 6 is a flow diagram of an example process for qualifying semantically linked policy information and applying the qualified policy information in generating certificate of insurance documents; and

FIG. 7 is an example graphical user interface for previewing and finalizing the generation of a certificate of insurance.

### DETAILED DESCRIPTION OF ILLUSTRATIVE EMBODIMENTS

The description set forth below in connection with the coordinating drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

As used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Further, the terms “approximately,” “about,” “proximate,” “minor variation,” and similar terms generally refer to ranges that include the identified value within some margin, such as, in some examples, 20%, 10%, or 5% in certain embodiments, as well as any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

Embodiments of the present disclosure integrate a fine-tuned Large Language Model (LLM) and/or artificial intelligence leveraging an insurance-specific ontology into a reduced latency or latency-free processing pipeline designed to extract insurance contract data, develop an enhanced and accurate understanding of a client request for a certificate of insurance, and automatically generate the certificate of insurance. The certificate of insurance, for example, may be generated in near real-time. Further, in some embodiments, the solution may be structured to function in a generally self-service manner. The insurance-specific ontology, for example, may map insurance policy attributes to elements (e.g., data fields) of a certificate of insurance template to consistently correlate insurance policy attributes to certificate of insurance document sections. In another example, a business-specific ontology or knowledge graph may map business organizations to enriched information (e.g., addresses, contact information, etc.) as well as interrelationships between business organizations to ensure consistent and complete referencing of entities (e.g., insured organizations, insurance carriers, individuals, and/or requesting organizations that will be certificate holders) within the generated certificate of insurance. Artificial intelligence may analyze values corresponding to request attributes (e.g., extracted from one or more request documents) as well as policy attributes (e.g., extracted from one or more insurance policy documents) in view of a business and/or insurance-specific ontology to consistently and accurately identify relevant details to include in a certificate of insurance and to enhance the provided information with additional details. The additional details, in some examples may be derived from business relationships, insurance servicing practices, insurance policy brokering rules, and/or certificate of insurance requirements stored within the semantically linked relationships of the business and/or insurance specific ontology.

In some embodiments of the present disclosure, to further enhance the certificate of insurance generation process, an end user may be presented, at one or more points in the cycle, with an interactive graphical user interface designed to visually represent attribute names, data fields, or other details linked or tagged to the original extracted attribute values. The end user, for example, may confirm and/or correct the connections made through the automated process by artificial intelligence classifiers, such as, in some examples, one or more machine learning models, artificial intelligence networks, and/or large language models (LLMs). The artificial intelligence classifiers may be further trained and/or fine-tuned, as appropriate, based on corrections applied by the end user. The end user, for example, may be an insurance broker.

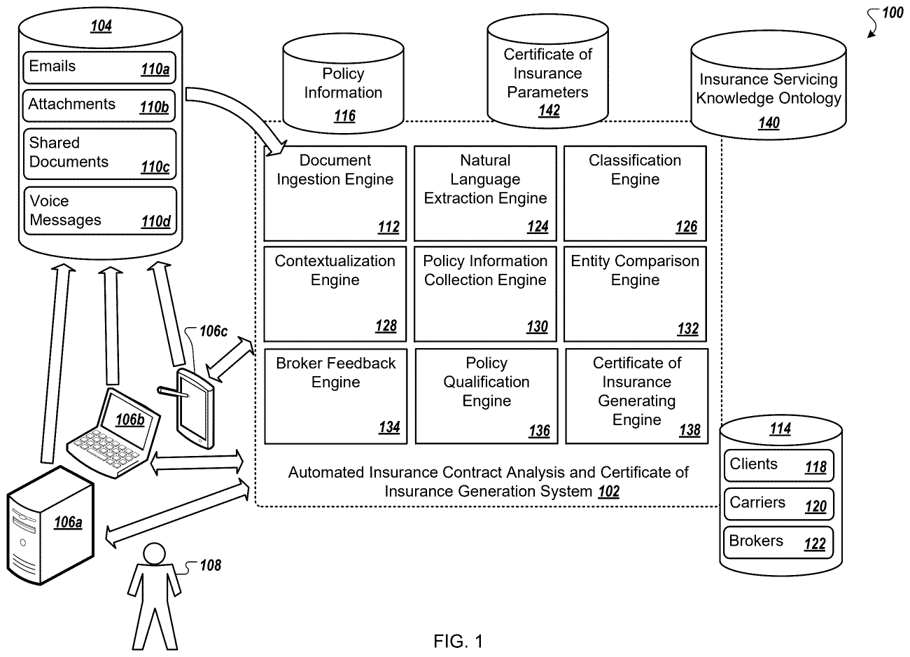

FIG. 1 is a block diagram of an example system 102 and architecture 100 for extracting certificate of insurance request parameters obtained from a collection 104 of unstructured and/or semi-structured documents 110 gathered from a variety of computing devices 106 used by brokers (such as a broker 108) communicating with clients, analyzing policy information 116 to extract contract data related to each certificate of insurance request, and applying the contract data in generating a corresponding certificate of insurance. The documents 110, in some examples, may include emails 110a, email attachments 110b, shared documents 110c (e.g., exchanged via a platform, file transfer service, etc.), and/or digital recordings of voice messages 110d. At least a portion of the documents 110, in some embodiments, are automatically gathered from each of the computing devices 106 (e.g., a server 106a, portable computer 106b, and/or personal computing device 106c, etc.). In some embodiments, at least a portion of the documents 110 are transferred to the collection 104 (e.g., data storage region accessible to the system 102) upon request or instruction by the broker 108 (e.g., drag and dropped or otherwise shared with the system 102).

The various engines (e.g., processing units) of the system 100, in some embodiments, are configured as software routines or processes (e.g., at least a portion of a software program) coded as instructions (e.g., software code) for executing on processing circuitry, such as one or more processors. Certain engines or operations performed by certain engines, in some embodiments, are configured as hardware logic (e.g., hardware-based operations) hard-coded or programmed into processing circuitry (e.g., logic circuitry), such as, in some examples, a programmable logic chip or other programmable logic device, an application-specific integrated circuit (ASIC), or a customized processor device. In an illustrative example, a software routine or process component of one of the engines may provide data and/or variable values (e.g., within a non-transitory computer-readable medium) for use by hardware logic of that engine.

A document ingestion engine 112 of the system 102, in some implementations, performs an initial ingestion of each of the documents 110 in the document collection 104. The document ingestion engine 112, for example, may perform an initial mapping of contractual information (e.g., insurance-related information) for cross-referencing with a policy information data store 116. For example, email recipients, document title, or other document naming convention may be used to identify a corresponding client of a set of carriers 118 captured in a business data store 114. Further, a source of the documents 110 (e.g., the broker 108) may be used to identify the corresponding broker 108 of a set of brokers 122 captured in the business data store 114. A document title, subject line of an email, or other information, in another example, may specify a particular carrier of a set of carriers 120 captured in the business data store 114 and/or insurance policy (e.g., policy reference identifier). The document ingestion engine 112, further, may obtain a portion of the information from metadata associated with certain documents 110, such as document metadata identifying the document's creator or email metadata identifying the recipient. The document ingestion engine 112 may organize the extracted information in a certificate of insurance parameters data store 142.

In some embodiments, the extracted information includes parameters for the contents of the certificate of insurance. The parameters may include specific details requested by a requesting entity (e.g., a business or individual requiring the certification of active insurance coverage as proof to supply to a customer, a business or individual interested in hiring an individual or organization contingent upon proof of insurance, etc.) regarding features of one or more insurance policies. In some examples, the parameters may relate to the insured's name and/or contact information (e.g., the policy holder(s)), insurance carrier information, policy number(s), effective date(s), type(s) of coverage, limit(s), deductible(s), co-insured's name(s) and/or contact information, and/or endorsements. The parameters may include details relevant to the operations requiring the certificate of insurance such as, in some examples, one or more locations, project identifiers, and/or type of operation(s). In another example, the parameters may include details relevant to a profession, such as indication of the requested COI being relevant to a type of artisan contractor, a type of consultant, a type of technical contractor, a type of small business, and/or a type of service (e.g., real estate agent, janitorial services, marketing firm, etc.). The parameters extracted, in further examples, may include the identification of the requesting entity and/or delivery parameters for delivering the certificate of insurance to the requesting entity and/or to the end audience (e.g., the potential customer of the requester).

In some implementations, the document ingestion engine 112 extracts text content from at least a portion of the documents 110. If certain documents are not yet in text form (e.g., PDF documents, graphic documents, etc.), in some embodiments, the document ingestion engine 112 performs optical character recognition (OCR) to recognize text content in those documents. Due to the uncertainty in recognizing characters by OCR, the document ingestion engine 112 may store metadata related to the extracted text regarding a confidence in the OCR performance.

In some implementations, the document ingestion engine 112 provides each document 110 to a natural language extraction engine 124 for recognizing meaningful information in each of the documents 110. For example, one or more text-based natural language processing (NLP) techniques may be applied to the body text of emails 110a, attachments 110b, and/or shared documents 110c to identify certificate of insurance request-related information, while vocalization-based NLP may be applied to the voice messages 110d. For example, NLP may be used to remove extraneous content such as signatures and greetings, while formatting the remaining content for further processing.

In some implementations, a classification engine 126 applies policy knowledge and/or broking service rules to organizing aspects of the document content. The classification engine 126, for example, may arrange the content supplied by the natural language extraction engine 124 into certificate of insurance aspects (e.g., parameters, as discussed above). Each certificate of insurance aspect identified within the document content, for example, may be tagged with a classification according to a classification schema (e.g., aspect of a policy, such as limit features, coverage features, etc.). The classification engine 126, in some embodiments, applies one or more machine learning models in tagging document content according to classification. The classification schema, for example, may be part of an insurance servicing knowledge ontology 140. The tagged document content may be stored to the certificate of insurance parameters data store 142.

In some embodiments, the tagged information is shared with the broker 108 to confirm the tags have been applied correctly and/or the values related to each tag (e.g., name, delivery instructions, etc.) have been captured correctly. In some implementations, the tagged and linked information is presented to the broker 108 via a broker feedback engine 134 for review. The broker feedback engine 134, for example, may prepare an interactive graphical user interface for presentation to the broker 108, allowing the broker 108 to amend or remove information automatically derived by the system 102 from the documents 104. Through the interactive graphical user interface presented at one of the computing devices 106, for example, the broker 108 may correct any mistakes within the automatically tagged aspects and/or delete certain tagged aspects, thereby removing those aspects from future processing.

In some implementations, a policy information collection engine 130 gathers insurance coverage details in accordance with the certificate of insurance parameters 142. The policy information collection engine 130, for example, may query the policy information data store 116 to locate relevant documents describing the coverage identified via the certificate of insurance parameters 142. The policy information data store 116, in some examples, may include contractional documents, transactional documents, and/or a database of information extracted therefrom and organized in accordance with various features of various types of insurance coverage (e.g., aspects of the insurance servicing knowledge ontology 140). In one example, at least a portion of the policy information is organized in a high-dimensional vector form, associated with an attribute tag or label. A tagging or labeling scheme, for example, may align with the tagging of the certificate of insurance parameters 142 for convenience of cross-referencing. At least a portion of the policy information 116, for example, may be stored in accordance with semantic relationships linked within a vector data store (e.g., a knowledge graph logically arranging information corresponding to a particular insurance policy or set of related insurance policies). In another example, a portion of the policy information may be collected from the document collection 104, such as an attachment 110b and/or shared document 110c including a portion of the relevant policy information.

If any portion of the policy information has not yet been classified and tagged, in some embodiments, the classification engine 126 applies policy knowledge and/or broking service rules to organizing aspects of the policy information 116. The classification engine 126, for example, may arrange a portion of the content supplied by the policy information collection engine 130 into certificate of insurance aspects (e.g., parameters, as discussed above). Each certificate of insurance aspect identified within the policy information 116, for example, may be tagged with a classification according to a classification schema (e.g., aspect of a policy, such as limit features, coverage features, etc.). The classification engine 126, in some embodiments, applies one or more machine learning models in tagging policy information 116 according to classification. The classification schema, for example, may be part of the insurance servicing knowledge ontology 140. The tagged document content may be stored to the policy information 116 and/or another data store.

In some implementations, an entity comparison engine 132 identifies individuals, organizations, or other business entities related to the request for certificate of insurance, such as the name of the insured individual(s) and/or organization(s), the carrier organization(s), and/or the requesting entity (e.g., business(es) or individual(s)) from the certificate of insurance parameters 142. The entity comparison engine 132, for example, may compare the information provided in the document collection 104 to known entities (e.g., the clients 118, carriers 120, brokers 122, and/or other organizations stored to the business data store 114) to resolve any discrepancies in spelling and/or formatting. The results of the entity comparison engine 132, for example, may assist the policy information collection engine 130 in retrieving a complete and relevant set of policy information corresponding to the request for certificate of insurance. In the event that a conflict is identified (e.g., the certificate of insurance parameters 142 contain one or more names that are similar to but not matching information located int the business data store 114), the broker feedback engine 134 may present the inconsistent information to an end user, such as the broker 108, to confirm the correct information.

In some implementations, a contextualization engine 128 creates semantic-based groupings of the tagged content (e.g., the certificate of insurance parameters 142 and policy information 116). The contextualization engine 128, for example, may logically link multiple aspects of a given layer of coverage. In another example, the contextualization engine 128 may logically link one or more certificate of insurance parameters 142 to a policy identifier, a client identifier, and/or another entity identifier. The contextualization engine 128, for example, may apply the logical links within the policy information data store 116, linking stored aspects together. The linked aspects, for example, can include links between individual certificate of insurance parameters 142 and individual features of one or more policies stored within the policy information.

The contextualization engine 128, in some embodiments, semantically groups the tagged content according to attributes, entities, and rules captured within the insurance servicing knowledge ontology 140. The insurance servicing knowledge ontology 140, for example, may include aspects of a business glossary as well as business rules defining relationships between tagged business terms. The insurance servicing knowledge ontology 140, for example, may be stored as a resource description framework (RDF).

In some embodiments, the contextualization engine 128 converts information stored in the policy information data store 116 and/or the certificate of insurance parameters data store 142 into a logically linked graph, framework, or neural network of information. The information, in some embodiments, may be stored in a vector form for later analysis using artificial intelligence, as described in greater detail below.

In some implementations, logically linked aspects of the content are analyzed by a policy qualification engine 136 to match the certificate of insurance parameters 142 to aspects of one or more insurance policies captured in the policy information 116. For example, the policy qualification engine 136 may ensure that the policy information gathered by the policy information collection engine 130 contains the requested details identified in the document(s) 110 representing the certificate of insurance request. The policy qualification engine 136, in some embodiments, applies the knowledge base of the insurance servicing knowledge ontology 140 to recognize relationships within the policy information 116. The insurance servicing knowledge ontology 140, for example, may include rules or other semantic relationships that can be used by the policy qualification engine 136 to recognize a complete set of details responsive to the certificate of insurance parameters 142.

If the policy qualification engine 136 determines that one or more of the certificate of insurance parameters 142 (e.g., requested details) do not align with the gathered policy information 116, in some implementations, the tagged and linked information is presented to the broker 108 via the broker feedback engine 134 for review. The broker feedback engine 134, for example, may prepare an interactive graphical user interface for presentation to the broker 108, allowing the broker 108 to amend relationships within or remove information from linked document content. Through the interactive graphical user interface presented at one of the computing devices 106, for example, the broker 108 may correct any mistakes within the automatically tagged and linked policy attributes, supply additional contractual information (e.g., documents, data, etc.), and/or abort the process due to the request for certificate of insurance failing to align with policy information (e.g., the system 102 lacks information related to the certificate of insurance parameters 142 corresponding to the request).

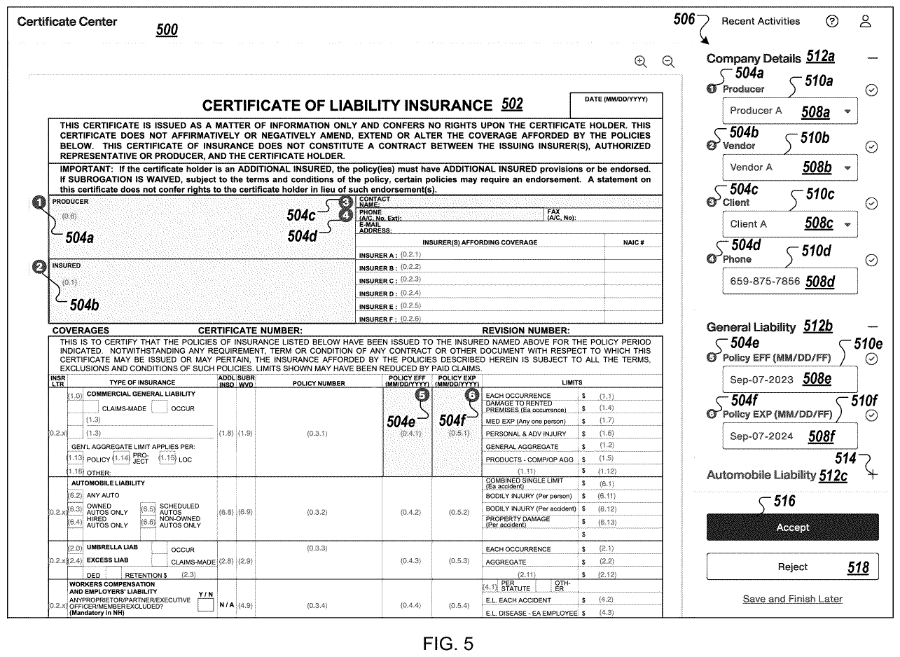

In some implementations, a certificate of insurance generating engine 138 obtains the qualified policy information 116 and the certificate of insurance parameters 142 and prepares a certificate of insurance for review by an end user, such as the broker 108. The certificate of insurance generating engine 138, for example, may organize the qualified policy information 116 within a standard graphical format, such as a graphical format represented in FIG. 5 (e.g., formatted under an ACORD certificate of insurance standard such as the ACORD 25 Certificate of Liability Insurance, created by the Association for Cooperative Operations Research and Development (ACORD) of Little Falls, NJ). The graphical representation may be provided in a report or interactive graphical user interface for review by the broker 108.

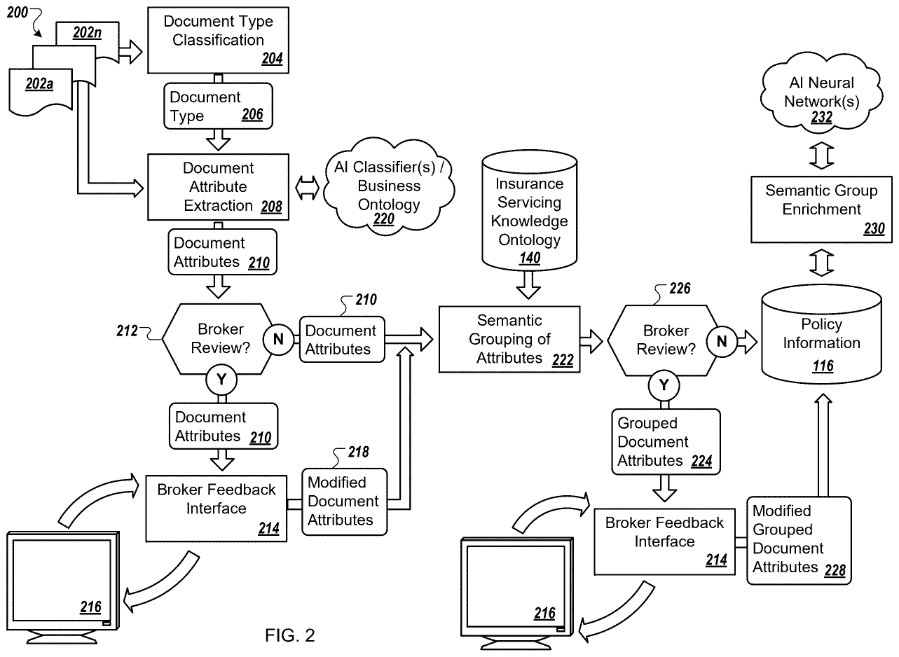

Turning to FIG. 2, a flow diagram of an example process 200 for extracting and organizing policy attributes from unstructured and/or semi-structured documents is presented. The process 200, for example, may be performed by the automated insurance contract analysis and certificate of insurance generation system 102 of FIG. 1.

The various processing units (e.g., engines) of the process 200, in some embodiments, are configured as software routines or processes (e.g., at least a portion of a software program) coded as instructions (e.g., software code) for executing on processing circuitry, such as one or more processors. Certain processing units or operations performed by certain processing units, in some embodiments, are configured as hardware logic (e.g., hardware-based operations) hard-coded or programmed into processing circuitry (e.g., logic circuitry), such as, in some examples, a programmable logic chip or other programmable logic device, an application-specific integrated circuit (ASIC), or a customized processor device. In an illustrative example, a software routine or process component of one of the processing units may provide data and/or variable values (e.g., within a non-transitory computer-readable medium) for use by hardware logic of that processing unit.

In some implementations, the process 200 begins with accessing, at a document type classification unit 204, one or more documents 202. The documents 202, for example, may include the email(s) 110a, the attachment(s) 110b, the shared document(s) 110c, and/or the voice message(s) 110d described in relation to FIG. 1. In further examples, the documents 202 may include contractual documents and other policy-related documents retrieved by the policy information collection engine 130 of FIG. 1 from the policy information data store 116. The document type classification unit 204, for example, may receive the one or more documents 202 via an application programming interface (API), retrieve the one or more documents 202 from a non-transitory computer-readable data store, or request the one or more documents 202 from a communication service (e.g., email service, broker-carrier communication portal, etc.). The documents, in one example, may have been ingested by the document ingestion engine 112 and/or formatted by the natural language extraction engine 124 of FIG. 1.

In some implementations, the document type classification unit 204 analyzes each document 202 to identify a document type 206 associated with each document 202. The possible document types for the documents 110 of FIG. 1, in some examples, can include a relevant type (e.g., certificate of insurance request-related) versus an irrelevant type (e.g., not placing a request for a certificate of insurance). In further examples, the potential document types included with the request for certificate of insurance and/or collected from the policy information 116 may include a type of insurance contract, a type of policy documentation, and/or a previously produced certificate of insurance. In the example of email documents 202, the document type classification unit 204 may recognize an insurance policy identifier in a subject line of the email, a party to the message in a metadata portion of the email (e.g., a known insurance carrier, client, and/or broker), and/or an entity identifier (e.g., client, carrier, broker, etc.) in the subject line and/or email metadata. In relation to shared documents (e.g., text, image, and/or PDF files, etc.), in another example, the document name, document metadata, and/or document storage location (e.g., if pulled from a storage system having dedicated storage regions per identifier) may be used to recognize a policy identifier, insurance carrier identifier, client identifier, and/or document type. If the document type classification unit 204 obtains identifying information for a policy, insurance carrier, and/or client, in some embodiments, the document type classification unit 204 cross-references the identifying information with additional supporting documentation (e.g., involving the policy information collection engine 130 of FIG. 1).

A document attribute extraction unit 208, in some implementations, is configured to recognize, within text content of the document 202, a set of document attributes 210 related to an insurance policy and/or to certificate of insurance generation parameters. The document attribute extraction unit 208, for example, may perform a portion of the operations described in relation to the classification engine 126 of FIG. 1. The document attributes 210, in some examples, may each represent an aspect of a business ontology 220 related to the document type (e.g., type of insurance policy, former certificate of insurance, and/or request submission, etc.). In illustration, in relation to liability insurance for a construction project, the applicable business ontology 220 may map attributes corresponding to coverage and limits related to workplace accidents and injuries. Further, the business ontology 220 may include party identification (e.g., a carrier, a client, a broker, etc.). Using the business ontology 220, the document attribute extraction unit 208 may identify values related to each of a set of attributes presented in the document. The document attributes 210, in some examples, may be identified using optical character recognition (OCR), natural language processing (NLP), machine learning analysis, and/or neural network (e.g., artificial intelligence, foundational model, large language model, etc.) analysis. Upon identifying values associated with each attribute of the set of attributes, for example, the document attribute extraction unit 208 may label each attribute in accordance with the business ontology 220 and collect them as the document attributes 210. In illustration, a value of “Acme Underwriting Company” may be labeled with a value representing “insurance carrier.” The document attributes 210 may be stored to a temporary storage region or non-transitory computer readable storage medium by the document attribute extraction unit 208 for further processing.

In some embodiments, the document attribute extraction unit 208 applies one or more artificial intelligence classifiers (e.g., machine learning models, artificial intelligence networks, or large learning models) 220 configured to recognize terms according to a given business ontology (e.g., a customer services ontology, an insurance policy ontology, a certificate of insurance formatting ontology, etc.) and label those terms accordingly. Each AI classifier 220, for example, may be trained or fine-tuned using a corpus of documents including information pertaining to insurance policies and/or certificates of insurance. The documents may be truth labeled according to the relevant business ontology. In an illustrative example, each given machine learning model 220 may be configured using one or more Bayesian machine learning classifiers, such as random forest classifiers and/or k-nearest neighbor classifiers, to provide confidence-based identification and labeling of the document attributes 210. The AI classifiers 220, for example, may be trained to flag certain attributes for user review based upon a confidence level failing to reach a threshold level of confidence. Based upon feedback provided by an end user, for example, the training of the AI classifiers 220 may be updated to ensure accurate and consistent labeling.

If broker review is desired (212) in some embodiments, the document attribute extraction unit 208, after extracting the document attributes 210, provides the document attributes 210 to a broker feedback interface unit 214 for presenting the document attributes 210 on a display 216 for review by a remote user (e.g., via a graphical user interface presented via a remote computing device) to allow the remote user to approve and/or update the values and/or labeling of the document attributes 210. The broker feedback interface unit 214, for example, may perform a portion of the operations of the broker feedback engine 134 of FIG. 1. If one or more of the values and/or labels of the document attributes 210 are adjusted by an end user via the user interface generated by the broker feedback interface unit 214, in some embodiments, modified document attributes 218 are produced.

The document attribute extraction unit 208, in some implementations, converts the values of the document attributes 210 and/or the modified document attributes 218 into vector format. The attribute values, for example, may each be converted to a numeric format arranged in a high-dimensional vector form. The high-dimensional vector form, for example, may be associated with its corresponding attribute tag or label.

In some implementations, the document attributes 210 or, if applicable, the modified document attributes 218, are used by a semantic grouping of attributes unit 222 to define relationships between the document attributes 210/modified document attributes 218. The semantic grouping of attributes unit 222, for example, may perform similar operations to those described in relation to the contextualization engine 128 of FIG. 1.

The semantic groupings of attributes unit 222, in certain embodiments, generates semantic links according to a taxonomy of policy information related to the document type 206 (e.g., a portion of the insurance servicing knowledge ontology 140). The taxonomy may include, in some examples, aspects related to various geographies, carriers, and/or insurance types.

The semantic grouping of attributes unit 222, in some implementations, arranges, or clusters, the vector forms of the grouped document attributes 224 into semantic relationships linked within a vector data store, such as a knowledge graph (e.g., graph neural network). The knowledge graph, for example, may be stored as the policy information 116.

If broker review is desired (226) in some embodiments, the semantic grouping of attributes unit 222, after semantically organizing the document attributes 210, 218 as the grouped document attributes 224, provides the grouped document attributes 224 to the broker feedback interface unit 214 for presenting the document attributes 210 on a display 216 for review by a remote user (e.g., via a graphical user interface presented via a remote computing device) to allow the remote user to approve and/or update the correspondences and/or relationships captured in the grouped document attributes 224. The broker feedback interface 214, in another example, may be provided the opportunity to update attribute values and/or tags or labels, as described in relation to review of the document attributes 210, above. For example, rather than two separate review cycles, broker feedback may be requested at a single time. In another example, broker feedback may only be pursued in relation to document attribute extraction in the circumstance where the document attribute extraction unit 208 identifies a desire for review (e.g., lower than a threshold confidence in portions of the tagged/labeled attributes), while the second feedback request may provide the end user to update any information. If one or more of the values and/or labels of the document attributes and/or the relationships defined through the linking of the grouped document attributes 224 are adjusted by an end user via the user interface generated by the broker feedback interface unit 214, in some embodiments, modified grouped document attributes 228 are produced. The modified grouped document attributes 228 may be stored to the policy information 116 as described above. In another example, the modified grouped document attributes 228 may be used to update the insurance servicing knowledge ontology 140. In an illustrative example, the modifications may be used to remove duplicate, similar information stored regarding a client or other organization such that the proper spelling and/or proper formatting of the name is retained and used in the future.

In some implementations, a semantic group enrichment unit 230 enriches the grouped document attributes 224 within the policy information 116 with relevant business knowledge. At least one artificial intelligence (AI) neural network 232 trained or fine-tuned with client servicing knowledge related to at least a segment of the document type 206 (e.g., the policy category as well as, potentially, one or more policy types within the policy category, a geographical region, etc.), for example, may enrich certain grouped document attributes with richer contextual information.

Although described in relation to a flow of operations involving a particular set of processing units, in other embodiments, the process 200 may include more or fewer processing units. For example, the process 200 may include an optical character recognition processing unit to assist in document attribute extraction and/or a vector indexing processing unit for storing the grouped document attributes 224 to the policy information data store 116. Further, although described in relation to a particular flow of operations, in other embodiments, certain aspects of the process 200 may be performed in a different order. For example, the grouped document attributes 224 may be provided for user feedback via the broker feedback interface 214 after the semantic groups of attributes have been enriched by the semantic group enrichment unit 230. Other modifications of the process 200 are possible.

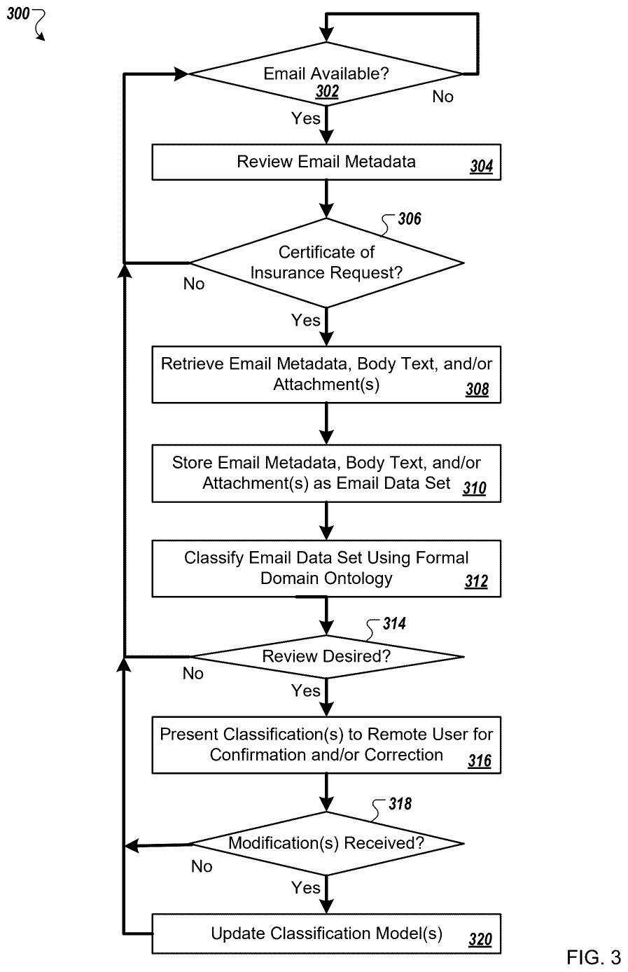

FIG. 3 illustrates a flow chart of an example method 300 for analyzing email documents to classify certificate of insurance parameters and, if applicable, other (e.g., policy-related) information contained therein. Portions of the method 300, for example, may be performed by the automated insurance contract analysis and certificate of insurance generation system 102 of FIG. 1. The method 300, for example, may perform a portion of the operations executed by the process 200 of FIG. 2.

In some implementations, the method 300 begins with identifying availability of an email (302). A widget, bot, or extension to an email program, in one example, may be configured to recognize receipt of emails for automatic review. In another example, an email may be flagged (e.g., shifted to a special folder, tagged with a dedicated marker within the email application) by a broker via a personal computing device. The email may be one of the emails 110a of FIG. 1.

In some implementations, the email metadata is reviewed (304). Metadata such as, in some examples, a sender identifier (e.g., name, email address, etc.), a recipient identifier, a subject line, a timestamp, and/or a description may be retrieved from the email document. The subject line, for example, may be reviewed for a transaction identifier related to a particular transaction (e.g., an insurance policy or a certificate of insurance request). In another example, other metadata, such as the sender identifier and/or the description, may be matched to an insurance policy. In illustration, the phrase “certificate of insurance,” “certificate of [fill-in-the-blank] insurance” such as “certificate of worker's compensation insurance” or “certificate of liability insurance,” or the acronym “COI,” may be recognized in the subject line or body of the email. In another illustrative example, an attachment may include a file name identifying it as a certificate of insurance template (e.g., “Sample_COI. pdf”).

In some implementations, if the email is recognized as relating to a certificate of insurance request (306), the email metadata, body text, and/or attachments are retrieved (308). The information, for example, may be retrieved for ingestion by the document ingestion engine 112 of FIG. 1.

In some implementations, the email metadata, body text, and/or attachments are stored as an email data set (310). The document ingestion engine 112 of FIG. 1, for example, may create a local copy of at least a portion of the email for analysis by further engines of the system 102. The storage, for example, may be a temporary binary large object (blob) storage for holding unstructured data pending processing.

In some implementations, the email data set is classified using a formal domain ontology (312). The contents of the email data set, for example, may be classified as described in relation to the classification engine 126 of FIG. 1. The formal domain ontology may be part of the insurance servicing knowledge ontology 140 of FIG. 1. The classification process, for example, may include a portion of the process 200 of FIG. 2 such as, in some examples, operations described in relation to the document attribute extraction processing unit (208). In some embodiments, classification involves providing formatted portions of the email data set to at least one trained machine learning classifier and/or artificial intelligence network (e.g., the ML model(s) 220 of FIG. 2) for performing unsupervised learning techniques in classifying the contents of the portion(s) of the email data set. The machine learning classifier(s) and/or artificial intelligence network(s), for example, may be configured to recognize attributes within the portion(s) of the email data set according to the formal domain ontology (e.g., the insurance servicing knowledge ontology 140 of FIG. 1 and/or the business ontology 220 of FIG. 2). The formal domain ontology, for example, may be an insurance policy-specific ontology and/or a certificate of insurance-specific ontology including terminology, relationships, and business rules related to presenting proof of insurance regarding a particular policy category or type. The policy categories, in some examples, may include workers'compensation insurance, auto liability insurance, professional liability insurance (i.e., errors and omissions insurance), and/or general liability insurance. The policy types, in some examples, may include various lines of business such as, in some examples, construction and/or transportation. In some embodiments, the formal domain ontology includes at least one geographic-specific insurance servicing ontology (e.g., North America, Europe, EMEA (Europe, the Middle East, and Africa), Asia-Pacific (APAC), etc.).

In some implementations, if a review is desired (314), at least one of the classifications is presented to a remote user for confirmation and/or correction (316). Review may be deemed to be desired, for example, based on the at least one trained machine learning classifier and/or artificial intelligence network determining a lack of threshold confidence associated with the classifying of at least one attribute of the email data set. For example, as described in relation to the broker feedback interface 214 of FIG. 2, document attributes 210 may be presented for review by a remote user.

If one or more modifications are received (318) responsive to presenting the classification(s) to the remote user, in some implementations, at least one classification model is updated (320). One or more new attributes and/or entities, for example, may be added to the trained machine learning classifier(s) and/or artificial intelligence network(s) based on the feedback received from the remote user. In another example, one or more rules may be modified or added based on the feedback received from the remote user. The updates regarding the rule(s), attribute(s), and/or entity(ies), for example, may be applied to the formal domain ontology.

Although described in relation to a particular set of operations, in other embodiments, the method 300 may include more or fewer operations. For example, the method 300 may include formatting operations, such as natural language processing and/or optical character recognition, to formation portions of the email data set in preparation for classifying (312). In another example, the email may be flagged, forwarded, or submitted for processing by the method 300 due to the email containing a certificate of insurance request such that, rather than determining whether the email is relevant to a certificate of insurance request (306), the email may instead simply be retrieved (308). Further, although described as a particular series of operations, in other embodiments, certain operations of the method 300 may be performed in a different order and/or concurrently. For example, the email metadata may be reviewed (304) after retrieving (308). Other modifications of the method 300 are possible.

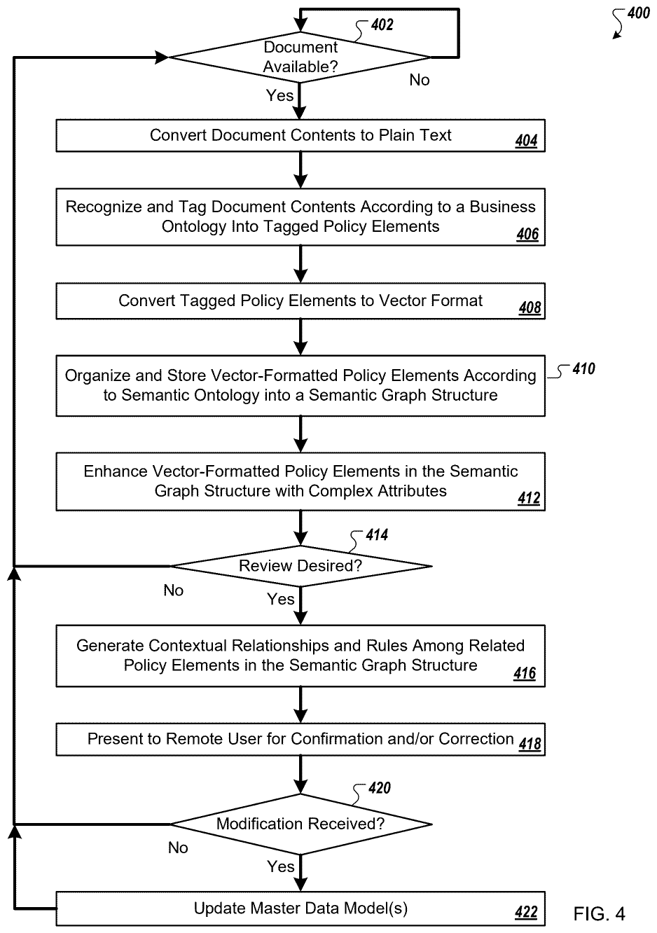

FIG. 4 is a flow chart of an example method 400 for converting policy information culled from document contents into semantically linked policy relationships. Portions of the method 400, for example, may be performed by the automated insurance contract analysis and certificate of insurance generation system 102 of FIG. 1. The method 400, for example, may perform a portion of the operations executed by the process 200 of FIG. 2.

In some implementations, the method 400 begins with determining whether a document is available (402). A widget, bot, or extension to an email program, in one example, may be configured to recognize receipt of emails for automatic review and pull any document attachments from the email. In another example, a document may be flagged (e.g., shifted to a special folder, tagged with a dedicated marker within the email application) by a broker via a personal computing device. The document, in illustration, may be dragged and dropped into a file transfer protocol (FTP) folder for document upload to a remote system, such as the system 102 of FIG. 1. The document may be one of the attachments 110b or shared documents 110c of FIG. 1. In a further example, the document may be collected and supplied as described in relation to the policy information collection engine 130 of FIG. 1.

When a document is available for processing (402), in some implementations, the contents of the document may be converted to plain text (404). Optical character recognition, in one example, may be performed on the document to recognize text within. A Microsoft Word document, in another example, may be converted from docx format to a plain text format. The document ingestion engine 112 and/or the natural language extraction engine 124 of FIG. 1, for example, may process the document to convert it to plain text.

In some implementations, the document contents are recognized according to a business ontology and tagged into tagged policy elements (406). The business ontology may be the insurance servicing knowledge ontology 140 of FIG. 1. The document contents may be recognized and tagged, for example, by the classification engine 126 of FIG. 1. The document may be tagged, in another example, as described in relation to the document attribute extraction unit 208 of FIG. 2. Each tagged policy element, for example, may include a word or phrase corresponding to a concept captured in the business ontology.

In some implementations, the tagged policy elements are converted to vector format (408). The document attribute extraction unit 208 of FIG. 2, for example, may convert the tagged policy elements to vector format. The vector format, for example, may capture the semantic meaning of the tagged word or phrase of each policy element in a manner consistent with the business ontology.

In some implementations, the vector-formatted policy elements are organized and stored according to a semantic ontology into a semantic graph structure (410). The semantic grouping of attributes unit 222 of FIG. 2, for example, may organize the vector-formatted policy elements into a semantic graph structure (e.g., as stored in the policy information data store 116). The semantic ontology, for example, may include an insurance servicing ontology specific to the document type (e.g., document type 206 of FIG. 2). The semantic ontology may include rules, relationships, and hierarchies of information related to, in some examples, at least one insurance category and/or type of insurance coverage within the insurance category, at least one geographic region associated with an insurance policy, and/or at least one insurance carrier (e.g., formatting styles, terminology styles, organizational styles, and/or other patterns and/or attributes associated with a particular carrier). Organizing the vector-formatted policy elements may include linking related policy elements that have a semantic association into a chain of dependencies (e.g., classes, properties, and/or entity types). In another example, organizing the vector-formatted policy elements may include arranging hierarchically related policy elements or linked chains thereof in a hierarchical structure (e.g., a tree-based structure). The semantic graph structure, for example, may be a rule-based semantic graph arranged in a manner that comports with business rules of the semantic ontology.

The semantic ontology or a separate business-relationship semantic ontology, in some implementations, includes information useful in linking entities of the policy information, such as clients 118, carriers 120, and/or brokers 122, as described in relation to FIG. 1. The business relationship-directed semantic ontology, for example, may include corporate relationships such as, in some examples, subsidiaries, acquisitions, name changes, mergers, and/or foreign translations of names. In another example, the business relationship-directed semantic ontology may map informal organization identities (e.g., “nicknames,” common names, abbreviations such as stock market ticker identifier, and/or misspellings) to formal (e.g., legal, full, etc.) organization identities. In further examples, the business relationship-directed semantic ontology may include client affiliations (e.g., organization(s) an individual is associated with, title within each organization, etc.) and/or business relationships (e.g., partnerships, vendor agreements, and/or collaborations between) between clients. In some embodiments, the business relationship-directed semantic ontology includes information useful in enriching details regarding entities. The business relationship-directed semantic ontology, for example, may include a mapping between identities (e.g., clients 118, carriers 120, and/or brokers 122) and entity details (e.g., mailing address, address of incorporation, headquarters address, email address(es), telephone number(s), etc.). The entity comparison engine 132 of FIG. 1, for example, may enhance entity information related to the certificate of insurance request using the business relationship-directed semantic ontology.

In some implementations, the vector-formatted policy elements in the semantic graph structure are enhanced with complex attributes (412). The enhancement, for example, may be performed by the semantic group enrichment unit 230 of FIG. 2. Additional relationships, correspondences, and/or rules governing the organization of the vector-formatted policy elements within the semantic graph structure, for example, may be formed by analyzing the semantic graph structure in view of a preexisting knowledge base. One or more machine learning models and/or artificial intelligence networks, for example, may be trained to recognize relationships and enhance the semantic graph structure according to the business knowledge trained or fine-tuned into the machine learning model(s) and/or AI network(s). The AI neural network(s) 232 of FIG. 2, for example, may analyze the semantic graph structure to enhance its contents with complex attributes. The complex attributes, for example, may include entity details such as, in illustration, mailing address, address of incorporation, headquarters address, email address(es), and/or telephone number(s). In another example, the complex attributes may include mapping relationships between entities, such as recognizing corporate structure relationships between separate organizations stored within the insurance service knowledge ontology 140. In another example, the complex attributes may include attributes of the insurance contract(s) underlying the request, such as, in some examples, policy number(s), type(s) of coverage, limits, effective date(s), expiration date(s), and/or carrier(s). The complex attributes, in a further example, may include a link to a standardized certificate of insurance template for use in generating the COI in response to the request, such as the ACORD 25 template. In a similar example, the complex attributes may include links between individual policy attributes and sections of a standardized certificate of insurance template relevant to the request or tags referencing sections of the standardized certificate of insurance template. In some embodiments, the complex attributes include relational links between the parameters of the present request and pre-existing certificate of insurance parameters previously stored in relation to a similar request. The similar request, in some examples, may have involved a previously generated certificate of insurance having a different template structure, a different requester, and/or covering a prior timeframe of insurance coverage.

In some implementations, if a review is desired (414), contextual relationships and rules among the related policy elements in the semantic graph structure are generated (416). The contextual relationships and rules, for example, may be derived from the linking structure applied during organization and storage of the vector-formatted policy elements. Certain contextual relationships and rules, in another example, may be derived from the complex attributes added as enhancements to the vector-formatted policy elements. The contextual rules and relationships, for example, may be generated in a manner that enables presentation for human review.

In some implementations, the policy elements, organized according to their contextual relationships and rules, are presented to a remote user for confirmation and/or correction (418). The policy elements, for example, may be arranged in a graphical user interface by the broker feedback interface unit 214 of FIG. 2.

Turning to FIG. 5, in illustration, an example user interface 500 for enabling end user confirmation and/or adjustment of semantically linked policy information is shown. The policy information, for example, may have been obtained at least in part through extracting policy information 116 from one or more files 110, such as the emails 110a, attachments 110b, shared documents 110c, and/or voice messages 110d of FIG. 1 that contain details related to a requested certificate of insurance. In a main pane of the example user interface 500, a certificate of liability insurance template 502 includes a set of labels 504a-f (e.g., numbers 1-6, encircled) aligned with attribute fields upon the certificate of liability insurance template 502. The set of labels 504a-f are also presented in a right pane 506 of the example user interface 500 along with a corresponding control 508a-f configured to receive a modification to an attribute 508a-f presented within or upon the control 510a-f. The example user interface 500, for example, may be generated by the broker feedback engine 134 of FIG. 1 or the broker feedback interface unit 214 of FIG. 2, aligning certificate of insurance parameters or document attributes 210 with a certificate of insurance template. Document attribute types, in some embodiments, are linked to or associated with fields of one or more standardized certificate of insurance templates within the insurance servicing knowledge ontology 140 for use in aligning information for broker review and for generating the eventual certificate of insurance.

As illustrated, a first label 504a corresponds to a producer attribute 508a, identified within the control 510a of a company details section 512a of the right pane 506 as being populated with the name “Producer A.” The producer, for example, represents the broker or agent responsible for issuing the certificate. The producer, in illustration, may be the end user reviewing the example user interface 500. If the producer attribute 508a is determined by the reviewer to be incorrect, the reviewer may select a different producer (e.g., one of the other brokers 122 stored to the business data store 114 of FIG. 1) from the drop-down menu control 510a.

A second label 504b corresponds to an insured attribute 508b, identified within the control 510b of the company details section 512a of the right pane 506 as being populated with the name “Vendor A.” The insured, for example, represents the holder of the insurance policy (e.g., one or more individuals and/or organizations). The insured, in other words, is the individual(s) and/or entit(ies) covered by the insurance policy. If the insured attribute 508b is determined by the reviewer to be incorrect, the reviewer may select a different insured entity (e.g., one of the other clients 118 stored to the business data store 114 of FIG. 1) from the drop-down menu control 510b.

A third label 504c corresponds to a contact attribute 508c, identified within the control 510c of the company details section 512a of the right pane 506 as being populated with the name “Client A.” The contact, for example, represents the requesting party of the certificate of insurance (e.g., one or more individuals and/or organizations). The requesting party, in other words, is the individual(s) and/or entit(ies) that initiated the certificate of insurance request and/or is identified as the party the request should be delivered to (e.g., in the circumstance that the insured 508b initiated the request on the behalf of the contact 508c). If the contact attribute 508c is determined by the reviewer to be incorrect, the reviewer may select a different contact (e.g., one of the other clients 118 stored to the business data store 114 of FIG. 1) from the drop-down menu control 510b. In other embodiments where the requesting party may not be known to the system 102, the reviewer may be provided the opportunity to replace or edit the contact attribute 508c (e.g., in accordance with information supplied in the files 110 or in a separate communication).

A fourth label 504d corresponds to a phone attribute 508d, identified within the control 510c of the company details section 512a of the right pane 506 as being populated with the digits “659-875-7856.” The phone attribute 508d, for example, represents the phone number of the requesting party of the certificate of insurance. If the phone attribute 508d is determined by the reviewer to be incorrect, the reviewer may edit or replace the phone number within the text box control 510d.

A fifth label 504e and a sixth label 504f, respectively, correspond to an effective date attribute 508e and an expiration date attribute 508f. The dates represented by the attributes 508e and 508f, for example, may be derived from an insurance policy that is a topic of the requested certificate of insurance. The effective date attribute 508e and/or the expiration date attribute 508f, for example, may be accessed from the policy information 116 of FIG. 1 by the policy information collection engine 130. If either of the date attributes 508e and 508f is determined by the reviewer to be incorrect, the reviewer may enter a different date into the corresponding text box control 510e or 510f of a general liability section 512b of the right pane 506.

As illustrated, additional fields may be available for review within the example user interface 510 by expanding at least one additional category, illustrated as an automobile liability section 512c in the right pane 506. The reviewer, for example, may activate an expansion control 514 to review attributes and controls related to an automobile liability policy.

Once the correct information has been confirmed and/or entered within the controls 510a-f, the reviewer may activate an accept control 516 to accept the attributes. Responsive to activating the accept control 516, in one example, the document attributes 210 and/or the modified document attributes 218 may be provided to the semantic grouping of attributes unit 222, as described in relation to FIG. 2. Conversely, if an error has occurred or the certificate of insurance is no longer needed, the review may activate a reject control 518 to abort the certificate of insurance generation process.

Returning to FIG. 4, in some implementations, if one or more modifications are received via presentation to the remote user (420), one or more master data models are updated (422). As illustrated in FIG. 5, for example, the information may be modified through interactions with one or more of the controls 510a-f. The modifications may be used to continue the learning process of one or more machine learning models and/or artificial intelligence networks to better identify information culled from policy documents and/or certificate of insurance requests in the future. For example, the modified grouped document attributes 228 of FIG. 2 may be used to update the training of the ML model(s) / business ontology 220 and/or the AI neural network(s) 232.

Although described in relation to a particular set of operations, in other embodiments, the method 400 may include more or fewer operations. For example, the method 400 may include storing original documents, such as the attachments 110b and/or other shared documents 110c related to the certificate of insurance request, for future reference and/or training purposes. Further, although described as a particular series of operations, in other embodiments, certain operations of the method 400 may be performed in a different order and/or concurrently. For example, as document contents are recognized and tagged (406), they may additionally be converted to vector format (408) in a concurrent processing pipeline. Other modifications of the method 400 are possible.

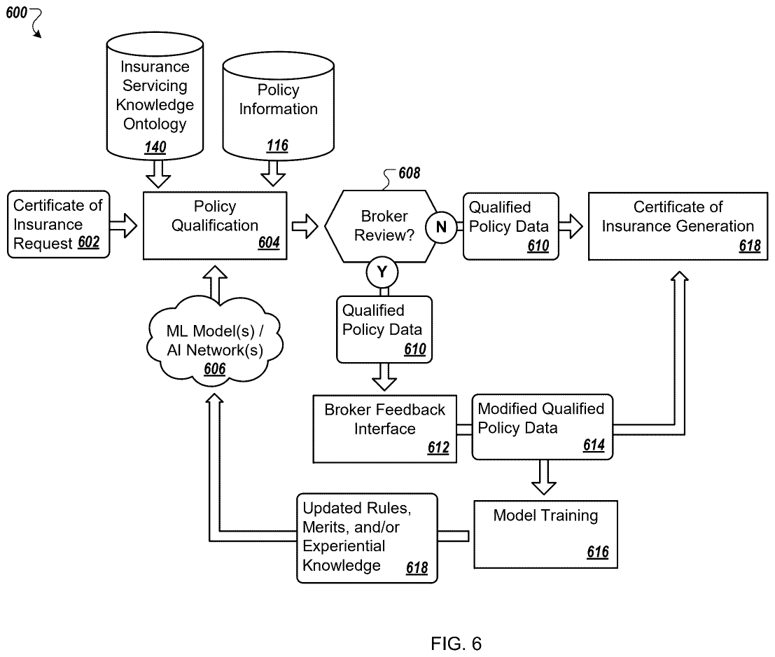

FIG. 6 is a flow diagram of an example process 600 for qualifying semantically linked policy information and applying the qualified policy information in generating a certificate of insurance. The process 600, for example, may be performed by the automated insurance contract analysis and certificate of insurance generation system 102 of FIG. 1.

In some implementations, the process 600 begins with receiving a certificate of insurance (COI) request 602. The COI request 602, for example, may be submitted via a user interface of a broker portal provided by the system 102 or a system in communication with the system 102. In another example, the COI request 602 may be submitted via an application programming interface (API). The COI request 602, in a further example, may be automatically generated based on receipt of certain information (e.g., an email 110a and/or other files 110b, 110c, and/or 110d containing certificate of insurance parameters). The COI request 602 may identify, in some examples, a type of COI template, parameters for the COI, and/or identification of at least one policy related to the visualization.

The various processing units (e.g., engines) of the process 600, in some embodiments, are configured as software routines or processes (e.g., at least a portion of a software program) coded as instructions (e.g., software code) for executing on processing circuitry, such as one or more processors. Certain processing units or operations performed by certain processing units, in some embodiments, are configured as hardware logic (e.g., hardware-based operations) hard-coded or programmed into processing circuitry (e.g., logic circuitry), such as, in some examples, a programmable logic chip or other programmable logic device, an application-specific integrated circuit (ASIC), or a customized processor device. In an illustrative example, a software routine or process component of one of the processing units may provide data and/or variable values (e.g., within a non-transitory computer-readable medium) for use by hardware logic of that processing unit.

In some implementations, based upon the COI parameters, the type of COI template, and/or one or more policy identifiers provided with the COI request 602, a policy qualification unit 604 collects, from the policy information 116, policy information corresponding to at least one policy to be named within the generated certificate of insurance. The policy qualification unit 604 may further collect COI parameters previously stored to the policy information 116, for example by the contextualization engine 128 of FIG. 1. The policy qualification unit 604, for example, may perform a portion of the operations described in relation to the policy qualification engine 136 of FIG. 1.

In some implementations, the policy qualification unit 604 applies business rules, merits (e.g., pro's and con's), and/or experiential knowledge to ensuring the policy information 116, including details regarding the insurance polic(ies), insured individual(s) and/or organization(s), operations details, delivery details, and any other attributes, are complete and correct. The quote qualification unit 604, for example, may supply gathered information (e.g., the policy information 116, etc.) to one or more machine learning models and/or artificial intelligence networks 606 trained and/or fine-tuned in business rules, merits, and/or experiential knowledge related to certificate of insurance generation. The business rules, for example, may include COI requirements dictated at a governmental level (e.g., county, state, federal, etc.) and/or by a professional accreditation organization relevant to the insured individual(s) and/or organization(s). The ML model(s) and/or AI network(s) 606, for example, may be trained or fine-tuned in view of a collection of historic certificates of insurance. The AI network(s) 606, for example, may include at least one large language model (LLM). The ML model(s) and/or AI network(s) 606, for example, may by prompted by the policy qualification unit 604 to use a portion of the insurance servicing knowledge ontology 140 as truth data along with the policy information 116 to apply relevant learned knowledge in assessing the completion and accuracy of the attributes to be used for certificate of insurance generation. The ML model(s) and/or AI network(s) 606, in some examples, may provide boilerplate terminology, identification of additional requisite attributes for compliance with state and/or professional associate guidelines, information regarding relative arrangement of the policy information 116, and/or a formatting or style for certain attributes to ensure compliance with business rules (e.g., address formatting, date formatting, etc.). In a further example, the ML model(s) and/or AI network(s) 606 may confirm compliance with delivery requirements. The ML model(s) and/or AI network(s) 606, for example, may collect and provide a set of certificate of insurance field values corresponding to a set of fields of a standardized certificate of insurance template. Further, the ML model(s) and/or AI network(s) 606 may identify an appropriate standardized certificate of insurance template based on one or more factors such as, in some examples, a geographic region, a type of insurance, an industry, or a profession. In another example, the appropriate standardized certificate of insurance template may be identified based at least in part on a certificate holder or requester.

If broker review is desired (608), in some implementations, a set of qualified quote data 610 may be provided to a broker feedback interface unit 612 (e.g., such as the broker feedback interface unit 214 of FIG. 2) to present an end user (e.g., broker) with factors of the analysis (e.g., warnings of lack of compliance, recommended additional attribute(s), modification(s) in formatting, etc.). The broker feedback interface unit 612, for example, may provide the end user with the opportunity to adjust and/or accept information presented within a graphical user interface. If the end user opts to modify one or more attributes of the qualified policy data 610 presented via the broker feedback interface unit 612, in some implementations, modified qualified policy data 614 is generated.

A model training unit 616, in some implementations, trains or fine-tunes at least one of the one or more ML model(s) and/or AI network(s) 606 according to the modified qualified policy data 614. For example, the training or fine-tuning may involve adjustments to initially trained rules, merits, and/or experiential knowledge 618.

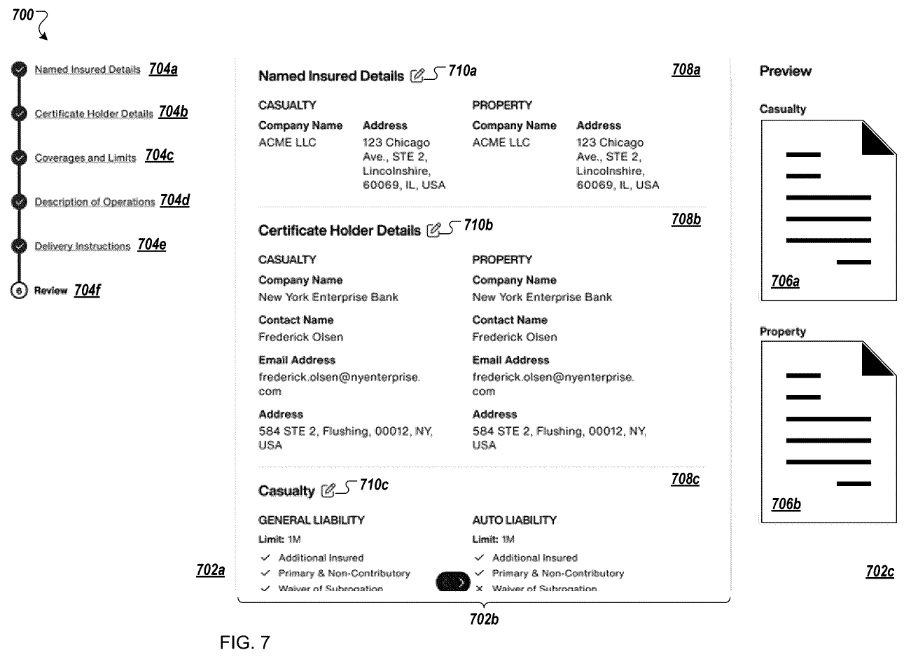

Turning to FIG. 7, an example user interface 700 for enabling end user confirmation and/or adjustment of certificate of insurance attributes is shown. The user interface 700 is divided into three areas: a navigation pane 702a, an attribute review pane 702b, and a certificate of insurance preview pane 702c. The example user interface 700, for example, may have been generated by the certificate of insurance generation unit 618 of FIG. 6.

As illustrated in the navigation pane 702a, the presentation in the user interface 700 represents a final review stage 704f. In the final review stage 704f, the COI preview pane 702c illustrates preview pages 706a and 706b (e.g., thumbnail images or thumbnail sized digital renditions of completed certificate of insurance document pages). As illustrated, the COI preview pane 702 presents one preview page one for each insurance policy (e.g., a casualty preview page 706a and a property preview page 706b). The preview pages 706a and 706b may each represent a filled in COI template, such as the template represented in the example user interface 500 of FIG. 5. Upon acceptance, the information represented within the preview pages 706a and 706b may be finalized and converted to at least one formal COI certificate.

Attributes used to populate the preview pages 706a and 706b are presented in sections 708 of the attribute review pane 704b. Three sections 708 are illustrated: a named insured section 708a, a certificate holder section 708b, and a casualty section 708b. Further sections, in some examples, may include a property section (e.g., corresponding to the property preview page 706b), a description of operations section (e.g., corresponding to a description of operations stage 704d), and/or a delivery instructions section (e.g., corresponding to a delivery instructions stage 704e). Each section 708a-c includes an edit control 710a-c selectable to present a user interface for adjusting attributes within the corresponding section 708. Upon selecting the edit control 710a within the named insured section 708a, for example, a user interface similar to the example user interface 500 of FIG. 5 may be presented to the reviewer, providing the opportunity to adjust information provided within the field (e.g., the filled in data field) corresponding to the first label 504b, such as the insured attribute 508b.

Although not illustrated, by scrolling downward through further sections 708, such as a property insurance section, the reviewer may be presented, at the bottom of the information, with a control that, when activated, generates the former COI document(s).

Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the process 200 of FIG. 2, the method 300 of FIG. 3, the method 400 of FIG. 4, and/or the process 600 of FIG. 6.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the devices 106a-c and the system 102 of FIG. 1, the system 102 of FIG. 1 and one or more storage devices storing the document collection 104, and/or the computing device driving the display 216 of FIG. 2 and the broker feedback interface unit 214.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in FIG. 5 and FIG. 7.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. The databases may include one or more vector databases organized to store high-dimensional data points each mathematically representing the meaning and context of at least a portion of an original file (e.g., text document, audio file, rich media file, image file, photograph, video file, etc.). The vector database(s), for example, may incorporate a set of search algorithms for performing vector similarity searches such as, in some examples, an exhaustive k-nearest neighbors (KNN) algorithm, an approximate nearest neighbor (ANN) algorithm, a Locality Sensitive Hashing (LSH) algorithm, a Hierarchical Navigable Small World (HNSW), and/or an Inverted File Index (IVF) algorithm. The vector database(s), further, may include an embedded query engine for submitting a request to the vector database(s). Unlike traditional databases and query systems, for example, a vector database query may respond with a set of similar assets (e.g., objects or items) to the query information based on similarity metrics (e.g., as calculated by the set of search algorithms). The vector database(s), in some examples, may be implemented by Microsoft® Azure Cosmos DB or Cloudflare Vectorize by Cloudflare, Inc. of San Francisco, CA. For example, the document collection 104, the certificate of insurance parameters 142, and/or the business data store 114 may be maintained in a database structure.

The systems described herein may communicate with the cloud computing environment through a secure gateway. In some implementations, the secure gateway includes a database querying interface, such as the Google BigQuery™ platform or Amazon RDS™. The secure gateway may include a vector database querying interface, such as Microsoft® Azure AI Search or Vertex AI Vector Search by Google®. The data querying interface, for example, may support access by the system 102 to the insurance servicing knowledge ontology 140 and/or the policy information 116 of FIG. 1, the document attribute extraction unit 206 and the business ontology 220 of FIG. 2, the semantic grouping of attributes unit 222 and the insurance servicing knowledge ontology 140 of FIG. 2, the modified grouped document attributes unit 226 and the policy information 116 of FIG. 2, and/or the policy qualification unit 604 and the insurance servicing knowledge ontology 140 and/or the policy information 116 of FIG. 6.

In some implementations, an edge server is used to transfer data between one or more computing devices and a cloud computing environment according to various embodiments described herein. The edge server, for example, may be a computing device configured to execute processor intensive operations that are sometimes involved when executing machine learning processes, such as document attribute extraction operations performed by the document attribute extraction unit 206 of FIG. 2, semantic enrichment operations performed by the semantic group enrichment unit 230 of FIG. 2, and/or policy qualification operations performed by the policy qualification unit 604 of FIG. 6. An edge server may include, for example, one or more GPUs that are capable of efficiently executing matrix operations as well as substantial cache or other high-speed memory to service the GPUs. An edge server may be a standalone physical device. An edge server may be incorporated into other computing equipment, such as a laptop computer, tablet computer, medical device, or other specialized computing device. Alternatively or additionally, an edge server may be located within a carrying case for such computing equipment. An edge server, in a further example, may be incorporated into the communications and processing capabilities of a mobile unit such as a vehicle or drone, or may otherwise be located within the mobile unit.

In some implementations, the edge server communicates with one or more local devices to the edge server. The edge server, for example, can be used to move a portion of the computing capability traditionally shifted to a cloud computing environment into the local environment so that any computation intensive data processing and/or analytics required by the one or more local devices can run accurately and efficiently. In some embodiments, the edge server is used to support the one or more local devices in the absence of a connection with a remote computing environment. The edge server may be configured to communicate with the one or more local devices directly or via a network. For instance, the edge server can include a private wireless network interface, a public wireless network interface, and/or a wired interface through which the edge server can communicate with the one or more local devices. In some embodiments, certain local devices may be configured to communicate indirectly with the edge server, for example via another local device. Further, the edge server may be configured to communicate with a remote computing (e.g., cloud) environment via one or more public or private wireless network interfaces.

In some implementations, the process 200 of FIG. 2, the method 300 of FIG. 3, the method 400 of FIG. 4, and/or the process 600 of FIG. 6 may be configured to be performed in part by an edge server or a device interoperating with an edge server. The device interoperating with the edge server, for example, may share processing functionality with the edge server via one or more APIs implemented by the processes.

The systems described herein may include one or more artificial intelligence (AI) neural networks for performing automated analysis of data. The AI neural networks, in some examples, can include a synaptic neural network, a deep neural network, a transformer neural network, and/or a generative adversarial network (GAN). The AI neural networks may be trained using one or more machine learning techniques and/or classifiers such as, in some examples, anomaly detection, clustering, and/or supervised and/or association. In one example, the AI neural networks may be developed and/or based on a bidirectional encoder representations for transformers (BERT) model by Google of Mountain View, CA.

The systems described herein may communicate with one or more foundational model systems (e.g., artificial intelligence neural networks). The foundational model system(s), in some examples, may be developed, trained, tuned, fine-tuned, and/or prompt engineered to evaluate data inputs such as the documents 202a-n of FIG. 2, the policy information 116 of FIG. 600, and/or the insurance servicing knowledge ontology 140 of FIG. 6. The foundational model systems, in some examples, may include or be based off of the generative pre-trained transformer (GPT) models available via the OpenAI platform by OpenAI of San Francisco, CA (e.g., GPT-3, GPT-3.5, and/or GPT-4) and/or the generative AI models available through Azure OpenAI or Vertex AI by Google of Mountain View, CA (e.g., PaLM 2).

Certain foundational models may be fine-tuned as AI models trained for performing particular tasks required by the systems described herein. Training material, for example, may be submitted to certain foundational models to adjust the training of the foundational model for performing types of analyses described herein.

Multiple foundational model systems may be applied by the systems and methods described herein depending on context. The context, for example, may include type(s) of data, type(s) of response output desired (e.g., at least one answer, at least one answer plus an explanation regarding the reasoning that lead to the answer(s), etc.). In another example, the context can include user-based context such as demographic information, entity information, and/or product information. In some embodiments, a single foundational model system may be dynamically adapted to different forms of analyses requested by the systems and methods described herein using prompt engineering.

While certain embodiments have been described, these embodiments have been presented by way of example only and are not intended to limit the scope of the present disclosure. Indeed, the novel methods, apparatuses and systems described herein can be embodied in a variety of other forms; further, various omissions, substitutions and/or changes in the form of the methods, apparatuses and systems described herein can be made without departing from the spirit of the present disclosure. The accompanying claims and their equivalents are intended to cover such forms or modifications as would fall within the scope and spirit of the present disclosure.

1. A system for automating creation of ad hoc certificates of insurance, the system comprising:
one or more first non-transitory storage devices configured to store a knowledge ontology comprising semantically linked relationships between a plurality of insurance policy attributes and a plurality of fields within at least one certificate of insurance template;
one or more second non-transitory storage devices configured to store semantically linked high-dimensional vector representations of portions of each insurance policy document of a set of insurance policy documents, wherein the semantically linked high-dimensional vector representations comprise a plurality of insurance policy attribute values corresponding to at least a subset of the plurality of insurance policy attributes;
one or more third non-transitory storage devices configured to store at least one large language model (LLM) tuned to assess completeness and accuracy of a subset of a plurality of insurance policy attribute values to be used for certificate of insurance generation; and
processing circuitry configured to
identify, via a widget, bot, or extension to an email program, availability of an email,
collect, from the email, an email data set comprising a metadata portion including a subject line and a sender identifier, and a body text portion,
identify, within the email data set, a plurality of certificate of insurance parameters
detailing a request for a certificate of insurance, wherein
the plurality of certificate of insurance parameters comprises information identifying a requesting party and one or more of a policy number, a policy holder name, a policy holder contact information, or a type of insurance policy,
apply a business relationship-directed semantic ontology comprising corporate relationships to enrich details regarding the policy holder contact information and the requesting party,
upon identifying a discrepancy between one or both of the policy holder contact information or the requesting party and the business relationship-directed semantic business ontology, present, at a first interactive graphic user interface, any inconsistent information to obtain correction.
using the email data set including the enriched policy holder contact information, identify at least one unstructured insurance policy document,
apply at least one natural language processing technique to extract, from each unstructured insurance policy document of the at least one unstructured insurance policy document, a set of insurance policy attribute values corresponding to at least a portion of the plurality of insurance policy attributes,
classify, by at least one trained classification model, each respective insurance policy attribute value according to a classification schema organizing the plurality of insurance policy attributes of the knowledge ontology,
convert each respective insurance policy attribute value of the set of insurance policy attribute values to a numeric format arranged in a respective high-dimensional vector form of a set of high-dimensional vector forms,
store the high-dimensional vector forms of the set of insurance policy attribute values to the one or more second non-transitory storage devices,
apply a respective attribute tag of a plurality of attribute tags to each high-dimensional vector form of the set of high-dimensional vector forms according to the classifying, wherein
at least a portion of the plurality of attribute tags reference a respective data entry field of a plurality of data entry fields of a topic certificate of insurance template of the at least one certificate of insurance template,
prepare, for presentation on a display of a remote computing device, a second interactive graphical user interface for reviewing each respective insurance policy attribute value of the set of insurance policy attribute values and a descriptor corresponding to the attribute tag applied to the respective insurance policy attribute value, wherein the descriptor corresponds to a label of an information field of the topic certificate of insurance template,
receive, responsive to presenting the second interactive graphical user interface, one or more modified insurance policy attribute values,
using the one or more modified insurance policy attribute values,
update training of the at least one trained classification model, and
update the set of high-dimensional vector forms according to the one or more modified insurance policy attribute values,
cluster the set of high-dimensional vector forms into semantic relationships linked within the one or more second non-transitory storage devices,
responsive to an indication of acceptance, received via the second interactive graphical user interface, of the set of insurance policy attribute values, analyze, by the at least one LLM, a plurality of vector representations stored to the one or more second non-transitory storage devices to identify a set of insurance policy attribute values of the plurality of insurance policy attribute values relevant to the request for the certificate of insurance, wherein
the plurality of insurance policy attribute values comprises one or more values corresponding to one or more of an effective date, an expiration date, a limit, or a deductible, and
the plurality of vector representations comprise at least a portion of the set of vector representations of the at least one unstructured insurance policy document,
match each data entry field of a plurality of data entry fields of the topic certificate of insurance template with a respective one or more insurance policy attribute values of the set of insurance policy attribute values or one or more certificate of insurance parameters of the plurality of certificate of insurance parameters according to a set of attribute tags of the plurality of attribute tags corresponding to a set of vector representations of the plurality of vector representations used in identifying the set of insurance policy attribute values, wherein
the matching is performed in accordance with the knowledge ontology, present, on the display of the remote computing device, a third interactive graphical user interface for reviewing and revising a digital rendition of the certificate of insurance, the digital rendition of the certificate of insurance comprising
a) based on the matching of each data entry field with the respective one or more insurance policy attribute values, a plurality of filled data fields comprising values of at least a portion of the plurality of insurance policy attributes and at least a portion of the plurality of certificate of insurance parameters, and
b) at least one edit control configured to enable editing of at least a portion of the plurality of filled data fields,
receive, responsive to presenting the third interactive graphical user interface, one or more modified values, each modified value corresponding to a different insurance policy attribute of the plurality of insurance policy attributes, and
using the one or more modified values, convert the values of the plurality of filled data fields into at least one formal COI certificate document.

2. (canceled)

3. The system of claim 1, wherein identifying the plurality of certificate of insurance parameters comprises applying at least one natural language processing technique to extract at least a portion of the certificate of insurance parameters from the email data set.

4. (canceled)

5. The system of claim 1, wherein the semantically linked high-dimensional vector representations are stored within a semantic graph structure.

6. (canceled)

7. The system of claim 1, wherein the at least one LLM matches each data entry field of the topic certificate of insurance template with the respective one or more attribute values.

8. The system of claim 1, wherein the digital rendition of the certificate of insurance comprises a thumbnail image of each page of the certificate of insurance.

9. (canceled)

10. The system of claim 1, further comprising one or more fourth non-transitory storage devices configured to store at least one machine learning model configured to recognize the plurality of insurance policy attributes, wherein
the at least one natural language processing technique formats content of the at least one unstructured insurance policy document for processing by the at least one machine learning model; and
the at least one machine learning model extracts the set of insurance policy attribute values.

11. The system of claim 1, wherein clustering the set of high-dimensional vector forms of the set of insurance policy attribute values comprises clustering the high-dimensional vector forms into semantic relationships linked within a knowledge graph, wherein the knowledge graph is stored to the one or more second non-transitory storage devices.

12. The system of claim 1, further comprising a second knowledge ontology comprising semantically linked relationships between a plurality of business entities, wherein:
the plurality of business entities comprises a plurality of insurance policy holders; and
the processing circuitry is further configured to analyze at least a portion of the plurality of certificate of insurance parameters in view of the second knowledge ontology to enhance entity details related to at least one of the policy holder name, the policy holder contact information, a certificate holder, or an insurance carrier.

13. The system of claim 1, wherein at least a portion of the processing circuitry comprises hardware logic hard-coded or programmed into the portion of the processing circuitry.

14.-20. (canceled)

21. The system of claim 1, wherein the at least one LLM is fined-tuned using a respective corpus of documents comprising insurance policies and certificates of insurance.

22. The system of claim 21, wherein the at least one LLM comprises a plurality of LLMs, each document of the respective corpus of documents used to fine-tune a respective LLM of the plurality of LLMs being truth labeled according to a different business ontology of a set of business ontologies.

23. The system of claim 22, wherein the set of business ontologies comprises at least one of a customer services ontology, an insurance policy ontology, or a certificate of insurance formatting ontology.

24. The system of claim 1, wherein analyzing, by the at least one LLM, the plurality of vector representations comprises prompting the at least one LLM to apply a portion of the plurality of high-dimensional vector forms and the knowledge ontology to collect and provide a set of field values for populating a plurality of attribute fields of the topic certificate of insurance template.

25. The system of claim 1, wherein identifying the at least one unstructured insurance policy document comprises identifying at least one attachment to the email as the at least one unstructured insurance policy document.

26. The system of claim 1, wherein the processing circuitry is further configured to analyze the email data set to identify the topic certificate of insurance template from the at least one certificate of insurance template, wherein
the at least one certificate of insurance template comprises a plurality of certificate insurance templates.

27. (canceled)

28. The system of claim 1, wherein the processing circuitry is configured to:
identify, based at least in part on the plurality of certificate of insurance parameters, the topic certificate of insurance template from the at least one certificate of insurance template,
wherein
the at least one certificate of insurance template comprises a plurality of certificate insurance templates.

29. The system of claim 28, wherein the processing circuitry is configured to identify, based at least in part on one or more of a geographic region, a type of insurance, an industry, or a profession identified in the request for the certificate of insurance, the topic certificate of insurance template.

30. The system of claim 1, wherein:
the processing circuitry is configured to, prior to identifying the plurality of certificate of insurance parameters, review at least the metadata portion of the email to determine whether the email is related to a certificate of insurance request; and
the plurality of certificate of insurance parameters are identified responsive to determining the email is related to the certificate of insurance request.

31. The system of claim 1, wherein the processing circuitry is configured to, prior identifying the plurality of certificate of insurance parameters:
convert each attachment of at least one attachment to the email to plain text; and
store the plain text of the at least one attachment, the body text portion, and the metadata portion to a non-transitory storage region as the email data set.

32. The system of claim 31, wherein the at least one attachment comprises the topic certificate of insurance template.
